(19) United States
(12) Patent Application Publication
(10) Pub. No.: US 2011/0040774 A1
(43) Pub. Date: Feb. 17, 2011

(54) Searching Spoken Media According to Phonemes Derived From Expanded Concepts Expressed As Text

(75) Inventors: Bruce E. Peoples, State College, PA (US); Michael R. Johnson, State College, PA (US); Kristopher D. Barr, Lemont, PA (US)

Correspondence Address: BAKER BOTTS LLP, 2001 ROSS AVENUE, 6TH FLOOR, DALLAS, TX, 75201-2980, US

(73) Assignee: Raytheon Company, Waltham, MA (US)

(21) Appl. No.: 12/541,244

(22) Filed: Aug. 14, 2009

(51) Int. Cl. G06F 17/30; G10L 15/18; G10L 13/08

(52) U.S. Cl. 707/765; 704/254; 704/E15.02; 704/E13.012; 707/E17.03

(57) ABSTRACT

According to one embodiment, searching media includes receiving a search query comprising search terms. At least one search term is expanded to yield a set of conceptually equivalent terms. The set of conceptually equivalent terms is converted to a set of search phonemes. Files that record phonemes are searched according to the set of search phonemes. A file that includes a phoneme that matches at least one search phoneme is selected and output to a client.

### TECHNICAL FIELD

This invention relates generally to the field of information management and more specifically to searching spoken media according to phonemes derived from expanded concepts expressed as text.

### BACKGROUND

A corpus of data may hold a large amount of information, yet finding relevant information may be difficult. Key word searching is a technique for finding information. In certain situations, however, known techniques for phonemes keyword searching of spoken media are not effective in locating relevant information.

### SUMMARY OF THE DISCLOSURE

In accordance with the present invention, disadvantages and problems associated with previous techniques for searching spoken media files may be reduced or eliminated.

According to one embodiment, searching media includes receiving a search query comprising search terms. At least one search term is expanded to yield a set of conceptually equivalent terms. The set of conceptually equivalent terms is converted to a set of search phonemes. Files that record phonemes are searched according to the set of search phonemes. A file that includes a phoneme that matches at least one search phoneme is selected and output to a client.

Certain embodiments of the invention may provide one or more technical advantages. A technical advantage of one embodiment may be that spoken media may be searched by converting the search terms of a search query to a set of search phonemes that can be used to search and retrieve media files that may include recorded speech. Another technical advantage of one embodiment may be that the search query may be formed in accordance with an expanded query concept graph that broadens an initial search. The graph includes expanded concept types expressed in text and converted to phonemes.

Another technical advantage of one embodiment may be that the phoneme search can be generated in a native language and conducted in any foreign language. Another technical advantage of one embodiment may be that retrieved spoken media files may be converted to text and/or translated from a foreign language to a native language. Another technical advantage of one embodiment may be that phonemes of retrieved files may be converted to graphemes that may be displayed and analyzed.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates one embodiment of a system configured to expand terms representing concepts, convert terms into phonemes, and search and retrieve spoken media files;

FIG. 2 illustrates an example of a conceptual graph;

FIG. 3A illustrates an example of a query conceptual graph;

FIG. 3B illustrates an example of a file conceptual graph;

FIG. 3C illustrates examples of onomasticons;

FIG. 4 illustrates an example of a method for generating and expanding terms representing concept types in a query conceptual graph and generating phonemes used to search spoken media files; and

FIG. 5 illustrates an example of a method for generating and expanding terms representing concept types in a conceptual graph generated for a spoken media file.

### DETAILED DESCRIPTION OF THE DRAWINGS

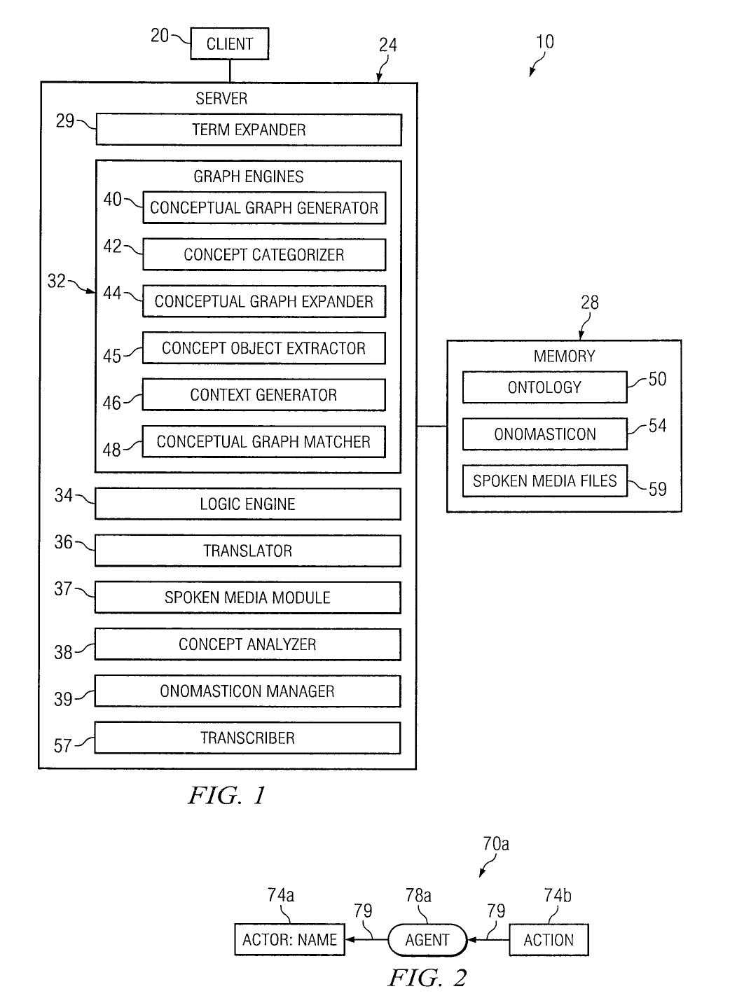

Embodiments of the present invention and its advantages are best understood by referring to FIGS. 1 through 5 of the drawings, like numerals being used for like and corresponding parts of the various drawings.

FIG. 1 illustrates one embodiment of a system 10 configured to expand terms representing concepts, convert terms into phonemes, and search spoken media files. In particular embodiments, system 10 may receive a search query with search terms. System 10 may convert the search terms to phonemes that can be used to search files that may include recorded speech. System 10 may retrieve a file that includes a phoneme that matches a phoneme of the search query. In particular embodiments, system 10 may transcribe speech to text. In particular embodiments, system 10 may translate files from a foreign language to a native language. In particular embodiments, system 10 may translate phonemes of the retrieved files to graphemes that may be displayed.

In the illustrated embodiment, system 10 includes a client 20, a server 24, and a memory 28. Server 24 includes a term expander 29, graph engines 32, a logic engine 34, a concept analyzer 38, a spoken media module 37, an onomasticon manager 39, a translator 36, and a transcriber 57. Graph engines 32 include a conceptual graph generator 40, a concept categorizer 42, a conceptual graph expander 44, a conceptual graph matcher 48, a concept object extractor 45, and a context generator 46. Memory 28 includes an ontology 50, an onomasticon 54, and spoken media files 59.

In particular embodiments, client 20 may send input to system 10 and/or receive output from system 10. In particular examples, a user may use client 20 to send input to system 10 and/or receive output from system 10. In particular embodiments, client 20 may provide output, for example, display, print, or vocalize output, reported by server 24.

In particular embodiments, client 20 may send an input search query to system 10. An input search query may comprise any suitable message comprising one or more query terms that may be used to search for spoken media files 59, such as phoneme representations of a key word or series of phoneme representations of key words. A term may comprise any suitable sequence of characters, for example, one or more letters, one or more numbers, and/or one or more other characters. An example of a term is a word. A phoneme may be the smallest linguistically distinctive unit of sound representing one or more letters, one or more numbers, and/or one or more other characters.

Server 24 stores logic (for example, software and/or hardware) that may be used to perform the operations of system 10. In the illustrated example, server 24 includes query expander 29, graph engines 32, logic engine 34, concept analyzer 38, and onomasticon manager 39, translator 36, and transcriber 57. Graph engines 32 include conceptual graph generator 40, concept categorizer 42, conceptual graph expander 44, conceptual graph matcher 48, concept object extractor 45, and context generator 46.

In particular embodiments, query expander 29 expands terms of an input search query. Query expander 29 may expand an input search query by determining related terms of the terms of (such as contained in) the query. The related terms may be determined by user selection and/or from ontology 50 and/or onomasticon 54. In particular embodiments, the related terms may be selected and/or ranked according to a particular source of a spoken media file 59. For example, a search may be requested for terms of (such as contained in) spoken media files 59 resulting from a news broadcast or a telephone conversation.

Graph engines 32 perform any suitable operations on conceptual graphs. In particular embodiments, graph engines 32 may generate, expand, and/or categorize concept types; match conceptual graphs; extract concept objects from files; and/or generate context of concept types by determining parts of speech. A conceptual graph may be a graph that represents concept types as terms (such as words) and the relationships among the terms representing concept types. An example of a conceptual graph is described with reference to FIG. 2.

FIG. 2 illustrates an example of a conceptual graph 70 (70a). In the illustrated example, conceptual graph 70a represents “ACTOR named NAME is the AGENT for ACTION.” A conceptual graph 70 includes concept type nodes, such as concept types 74 (74a and/or 74b) and relation nodes 78 (78a), coupled by directional arcs 79. Concept type nodes 74 include terms representing concept types, and a concept type node 74 represents a concept. Concepts may be expressed as subjects, direct objects, verbs, or any suitable part of language. In the illustrated example, concept type node 74a represents ACTOR, and concept type node 74b represents ACTION.

A concept type node 74 may have a concept type and a referent, expressed as A:B, where A represents the concept type and B represents the referent. The concept type specifies the concept, and the referent designates a specific entity (such as an existing entity) that is the referent. In the illustrated example, in concept node 74a, ACTOR is the concept type and NAME is the referent.

A relation node 78 represent a relationship between concepts. Relation node 78a represents AGENT, or an agent type relation. Arc 79 represents the direction of the relationship. Arc 79 indicates that ACTOR is the Agent of ACTION.

In particular embodiments, the terms and the relationships among the terms represented by conceptual graph 70 may be expressed in text. In certain embodiments, square brackets may be used to indicate concept type nodes 74, and parentheses may be used to indicate relation nodes 78. Arrows may be used to indicate arcs 79. In the illustrated example, the terms and relationships represented by conceptual graph 70a may be expressed as:

[ACTOR: NAME]←(Agent)←[ACTION]

The arrows are relational arrows that specify relations among nodes, but not with respect to an objective coordinate system. Accordingly, conceptual graph 70a may also be expressed as:

[ACTION]→(Agent)→[ACTOR: NAME]

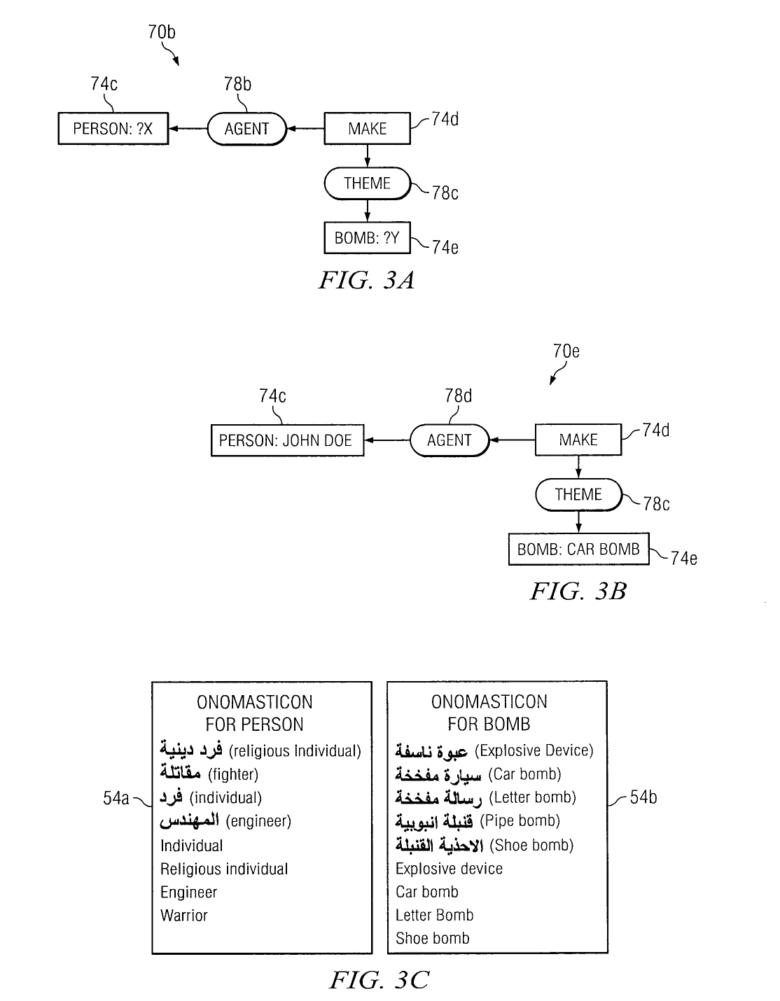

Referring back to FIG. 1, in particular embodiments, conceptual graph generator 40 generates a query conceptual graph 70 that may represent a search query. An example of a query conceptual graph 70 is described in more detail with reference to FIG. 3A.

FIG. 3A illustrates an example of a query conceptual graph 70 (70b). In the illustrated example, query conceptual graph 70b includes concept type nodes 74 (74c, 74d, and/or 74e) and relation nodes 78 (78b and/or 78c). In the illustrated example, query conceptual graph 70b may represent the query for spoken media files 59 related to “Person (undefined) Makes Bomb (undefined).” A question mark indicates that a concept referent is undefined. In the example, Person: ?x represents that Person contains no referent, and Bomb: ?y contains no referent. Relation node 78b indicates that Person: ?x is the Agent of Make. Relation node 78c represents a theme relation indicating that Bomb: ?y is the Theme of Make.

In the illustrated example, conceptual graph 70b may be expressed as:

[Person: ?x]←(Agent)←[Make]→(Theme)→[Bomb: ?y]

Concept types may be of a particular concept category, for example, a context linking concept or a concept object. A context linking concept links two or more relations, and is generally represented as a verb, but can be other parts of speech. In the illustrated example, Make is a context linking concept that links Agent and Theme, which may be expressed as:

(Agent)←[Make]→(Theme)

In the example, a context linking concept is linked by two or more arrows, or arcs 79, both leading away from the concept. This pattern may be used to identify context linking concepts. A conceptual graph 70 may have multiple context linking concepts. The main context linking concept may be designated as the prime context linking concept.

A concept object is linked to one or more relations in one direction only, and is generally represented as a noun, but can be other parts of speech. In the illustrated example, Person is a concept object that is linked to Agent in one direction, and Bomb is a concept object that is linked to Theme in one direction, which may be expressed as:

[Person: ?x]←(Agent)

(Theme)→[Bomb: ?y]

In the example, a concept object is linked by an arrow, or arc 79, pointing in one direction only. This pattern may be used to identify concept objects.

Referring back to FIG. 1, in particular embodiments, concept categorizer 42 may determine the concept categories, such as context linking concept or concept object, of the concepts of a conceptual graph 70. In particular embodiments, concept categorizer 42 may perform pattern matching to identify the concept category. As discussed above, a context linking concept is linked by two or more arrows, or arcs 79, leading away from it. A concept object is linked by an arrow, or arc 79, pointing in one direction only. In particular embodiments, concept categorizer 42 may associate a category identifier of a concept type with the concept type. For example, the category identifier may be appended to the concept. For example, a context linking concept or concept object may be appended. The category identifiers may be used to the search onomasticon 54 and/or ontology 50 for related terms.

In particular embodiments, conceptual graph expander 44 expands query conceptual graph 70b. Conceptual graph expander 44 may use term expander 29 to expand concept types of query conceptual graph 70b with a set of terms semantically related to the concept type term. Conceptual graph expander 44 may use category identifiers of a concept type to search onomasticon 54 and/or ontology 50 for related terms. A search query may be formed using the expanded terms representing concept types of a query conceptual graph.

Related terms may be terms that are similar to, for example, within the semantic context of the concept type of a conceptual graph. Examples of related terms include synonyms, hypenyms, holonyms, hyponyms, merronyms, coordinate terms, verb participles, and verb entailments. Related terms may be in the native language of the search (for example, English) and/or a foreign language (for example, Arabic, French, or Japanese). In one embodiment, a foreign language term may be a foreign language translation of a native language term performed by translator 36 related to the search, for example, a query term or a semantically related term.

A related term (RT) of a term may be expressed as RT(term). For example, a RT(Person) is Human.

In the illustrated example, examples of related terms may be as follows:

RT(Person): Individual, Religious Individual, Engineer, Warrior, etc.

RT(Make): Building, Build, Create from raw materials, etc.

RT(Bomb): Explosive device, Car bomb, Pipe bomb, etc.

The related terms may include the following Arabic terms (English translation in parentheses):

RT(Person): [symbol] (Person), [symbol] (Individual), [symbol] (Religious Individual), [symbol] (Engineer), [symbol] (Warrior), etc.

RT(Make): [symbol] (Make), [symbol] (Building), [symbol] (Build), [symbol] [symbol] (Create from raw materials), etc.

RT(Bomb): [symbol] (Bomb), [symbol] (Explosive device), [symbol] [symbol] (Car bomb), [symbol] [symbol] (Pipe bomb), etc.

Conceptual graph expander 44 may use term expander 29 to expand each term representing a concept type of query conceptual graph 70b by forming an expanded query conceptual graph 70b from the related terms:
[RT(Person): ?x]←(Agent)←[RT(Make)]→(Theme)→[RT(Bomb): ?y]
   For example, the following expanded query conceptual graph may be formed using expanded terms to represent concept types:
[RT(Individual): ?x]←(Agent)←[RT (Build)]→(Theme)→[RT(Explosive Device): ?y]

Expanded terms are mapped to the seed term representing the concept type in a concept graph 70, and may be stored in onomasticon 54. Examples of expanded terms for conceptual graph 70b are described in more detail with reference to FIG. 3C.

In particular embodiments, conceptual graph generator 40 generates a query return conceptual graph that may represent a query return, such as a spoken media file. In particular embodiments, conceptual graph generator 40 may use transcriber 57 to convert spoken media to text to generate a conceptual graph for a spoken media file. An example of a spoken media file conceptual graph 70e is described in more detail with reference to FIG. 3B.

FIG. 3B illustrates an example of a spoken media file conceptual graph 70e. In the illustrated example, spoken media file conceptual graph 70e includes concept type nodes 74 (74c, 74d, and/or 74e) and relation nodes 78 (78d and/or 78c). In the illustrated example, spoken media file conceptual graph 70e represents a retrieved spoken media file 59 that includes information about “Person (specified as John Doe) Makes Bomb (specified as Car bomb).”

In the illustrated example, file conceptual graph 70e may be expressed as:
[Person: John Doe]←(Agent)←[Make]→(Theme)→[Bomb: Car bomb]

Referring back to FIG. 1, in particular embodiments, conceptual graph expander 44 expands spoken media file conceptual graph 70e. Conceptual graph expander 44 may use term expander 29 to expand terms representing concept types of spoken media file conceptual graph 70e. Conceptual graph expander 44 may expand each concept type term of a spoken media file conceptual graph 70e with a set of terms related to the concept types. In particular embodiments, expanded spoken media file conceptual graph 70e may be compared with expanded query conceptual graph 70c to select files for a query return.

In the illustrated example, examples of related terms may be as follows:

RT(Person): Individual, Engineer, etc.

PRT(Make): Building, Build, Create from raw materials, etc.

RT(Car bomb): Explosive device, Bomb, etc.

Expanded terms are mapped to the seed term representing the concept type in a concept graph 70, and may be stored in onomasticon 54. Examples of expanded terms for conceptual graph 70e are described in more detail with reference to FIG. 3C.

In one example, the following expanded spoken media file conceptual graph may be formed using expanded terms to represent concept types:
[Individual: John Doe]←(Agent)←[Build]→(Theme)→[Explosive device: Car bomb]

In particular embodiments, conceptual graph matcher 48 matches query conceptual graphs 70c and spoken media file conceptual graphs 70e to select spoken media files that match the search query. In particular embodiments, expanded spoken media file conceptual graphs 70e and expanded query conceptual graphs 70b may be compared. In some particular embodiments, conceptual graph matcher 48 may use translator 36 to translate foreign terms to native terms to compare terms representing concept types in expanded conceptual graphs.

Graphs may be regarded as matching if some or all corresponding terms representing concept type nodes 74 and/or 78 match. Corresponding concept type nodes may be nodes in the same location of a graph. For example, concept type node 74c of graph 70b corresponds to node 74c of graph 70e. Nodes 74 and/or 78 may match if the one or more of the terms representing the concepts or relations of the nodes match. For example, concept type node 74c of graph 70b matches concept type node 74c of graph 70e. In the example, conceptual graph 70b and Conceptual graph 70e may be regarded as matching.

In particular embodiments, if a spoken media file conceptual graph 70e representing a spoken media file 59 matches query conceptual graph 70b, conceptual graph matcher 48 may select file 59 to report to client 20. In particular embodiments, logic engine 34 may send the selected file to transcriber 57 to convert the spoken media to text. In particular embodiments, logic engine 34 may send the transcribed text to translator 36 for translation , for example, from a foreign language to a native language. In particular embodiments, logic engine 34 may select certain text to report to client 20.

In particular embodiments, conceptual graph matcher 48 may use the concept category to search files. For example, if a concept type graph term is a context linking concept, then conceptual graph matcher 48 may search for a spoken media file conceptual graph that has the concept type graph term linked by two or more arcs leading away from it. If a concept type graph term is a concept object, then conceptual graph matcher 48 may search for a spoken media file conceptual graph that has the concept type graph term linked by an arc in only one direction. If a concept type graph term has an undefined referent (?x or ?y), then conceptual graph matcher 48 may search for a spoken media file conceptual graph that has the concept type graph term with a referent.

In particular embodiments, conceptual graph matcher 48 may sort selected files according to the proximity of matching. Matching proximity may be measured in any suitable manner. In certain examples, file conceptual graph 70e has more related terms that match the related terms of query conceptual graphs 70b, file conceptual graph 70e may be regarded as a more proximate match. If file conceptual graph 70e has fewer related terms that match the related terms of query conceptual graphs 70b, file conceptual graph 70e may be regarded as a less proximate match. In certain examples, file conceptual graph 70e with terms that are more similar to (semantically closer to) the terms of query conceptual graphs 70b may be regarded as a more proximate match. File conceptual graph 70e with terms that are less similar to (semantically farther away from) the terms of query conceptual graphs 70b may be regarded as a less proximate match.

In particular embodiments, graph engines 32 may perform other suitable operations. Graph engines 32 may include a concept object extractor 45 that can extract terms from term expander 29, spoken media files 59, ontology 50, or onomasticon 54 to construct conceptual graphs. Graph engines 32 may also include a context generator 46 that checks and determines the parts of speech of the extracted terms.

In particular embodiments, logic engine 34 checks the logic of conceptual graphs 70. Logic engine 34 may access ontology 50 to determine if the concepts, terms representing concepts, and relations represented by the conceptual graph 70 are being properly used. For example, logic engine 34 may check whether a term used as relation can be properly used as a relation between two concepts or terms representing concepts, or whether a term is being properly used as a context linking concept to link concept objects of conceptual graphs 70. A logic engine may use axioms to verify graphs 70.

In particular embodiments, concept analyzer 38 performs Formal Concept Analysis (FCA) to validate terms representing concept types. Concept analyzer 38 may check whether related terms representing concept types are sufficiently related to the seed (or graph) concept to validate the semantically equivalent terms generated by term expander 29 or conceptual graph expander 44.

In particular embodiments, concept analyzer 38 may check whether attributes mapped to the seed concept term are also mapped to the related terms representing concept types. Concept analyzer 38 may use a matrix to check attributes. The related terms representing concept types may be plotted along one dimension, and the attributes of the seed concept term may be plotted along another dimension. A cell represents whether or not an attribute is mapped to a particular potential term to represent a concept represent a concept type. If the attribute is mapped to the potential term represent a concept type, the cell is marked. If the attribute is not mapped, the cell is left unmarked. A related term should have a satisfactory number (such as some, most, or all) attributes mapped to it to represent a concept type.

In particular embodiments, spoken media module 37 is used to index spoken media files 59, convert text terms to phonemes, and search spoken media files 59. In the embodiments, spoken media module 37 may receive a search query with search terms. The search query may be formed in accordance with a term expander 29 or an expanded query concept graph. Spoken media module 37 may convert the search terms to phonemes that can be used to search spoken media files 59 that include recorded speech. Spoken media files 59 may be indexed by phonemes included in spoken media files 59. Spoken media module 37 may retrieve spoken media files 59 according to matching phonemes. For example, spoken media module 37 may retrieve a spoken media file 59 that includes a phoneme that matches a phoneme of the search query. Spoken media module 37 may use any suitable logic to perform operations, such as NEXIDIA FORENSIC SEARCH provided by NEXIDIA INC.

In particular embodiments, spoken media module 37 may output spoken media files 59 to client 20 in any suitable manner. For example, spoken media module 37 may play the phonemes of files 59.

In particular embodiments, transcriber 57 may convert phonemes of spoken media files 59 to text using any suitable logic, such as MEDIASPHERE provided by APPLICATIONS TECHNOLOGY, INC. In particular embodiments, translator 36 may translate converted speech to text from one language to another, such as from a foreign language to a native language, using any suitable logic, such as LW ENTERPRISE TRANSLATION SERVER provided by LANGUAGE WEAVER INC.

In particular embodiments, onomasticon manager 39 manages onomasticon 54. Onomasticon manager 39 may manage information in onomasticon 54 by performing any suitable information management operation, such as storing, modifying, organizing, and/or deleting information. Onomasticon manager 39 may perform the operations at any suitable time, such as when information is generated or validated.

In particular embodiments, onomasticon manager 39 may use concept categories, such as context linking concept or concept object, of the concepts of a graph 70 to search onomasticon 54.

In particular embodiments, onomasticon manager 39 may perform the following mappings: the query conceptual graph to the search query, the set of semantically related terms representing concept types to the a graph concept type, the set of semantically related terms to the search query, the expanded query conceptual graph to the query conceptual graph, the word sense to the semantically related terms of a search query, the set of semantically related terms to the word sense, the set of semantically related terms to the semantic context, and/or the semantic context to the search query.

In particular embodiments, concept object extractor 45 may extract terms from, for example, spoken media files 59, ontology 50, or onomasticon 59. The extracted terms may be used to construct conceptual graphs or may be displayed on client 20 in any suitable manner. In particular embodiments, context generator 46 may check and determine the parts of speech of the extracted terms. Components such as conceptual graph generator 40, concept categorizer 42, or conceptual graph matcher 48 may utilize the operations of context generator 46.

Memory 28 includes ontology 50, onomasticon 54, and spoken media files 59. Ontology 50 may describe terms, the attributes of terms, and the relationship among the terms. Ontology 50 may be used to determine the appropriate terms, attributes, and relationships. For example, ontology 50 may designate the attributes of a term and the valid relationships that the term may have with other terms. For example, ontology 50 may indicate that a person can make a bomb, but a lion cannot make a bomb.

Onomasticon 54 records information resulting from the operations of system 10 in order to build a knowledge base of queries, terms (for example, seed concept terms and semantically related terms representing concept types), attributes of terms, and relationships among terms. The information may be stored as conceptual graphs 70.

In particular embodiments, mappings among identifiers of queries, terms, attributes, relationships, conceptual graphs 70 may be used to indicate the connections among them. In certain examples, information related to a particular query may be linked to the query.

In particular embodiments, information in onomasticon 54 may be used for future searches. For example, term expander 29 may retrieve validated related terms mapped to a seed term (for example, semantically related terms that represent concept types) from onomasticon 54. As another example, conceptual graph generator 40 may retrieve a conceptual graph 70 mapped to a search query from onomasticon 54. As another example, conceptual graph expander 44 may retrieve an expanded conceptual graph 70 mapped to a non-expanded conceptual graph 70 from onomasticon 54.

Spoken media files 59 represent electronically stored files of any suitable media, such as text, converted from audio, audio, and/or visual medium containing audio.

In particular embodiments, spoken media files 59 record terms (or words), such as spoken or written terms, in any suitable language, such as a native or foreign language. For example, a spoken media file 59 may comprise an audio recording of speech or a document that includes text.

In particular embodiments, a spoken media file 59 may be indexed by phonemes. A phoneme may be a unit of a phonetic representation of a term used by language. The unit may correspond to a set of similar speech sounds that may be perceived to be a single distinctive sound in the language.

In particular embodiments, a spoken media file 59 may be indexed by the source type of the spoken media file 59, such as a telephone conversation, a broadcast (such as a news broadcast), a lecture, a speech, a surveillance recording, and/or other suitable source.

In particular embodiments, a spoken media file 59 that records speech may be mapped to graphemes that correspond to phonemes of the recorded speech. A grapheme may be a set of units (such as letters) of a writing system that represent a phoneme. A grapheme may be a phonetic spelling of a phoneme or may be a word that corresponds to a spoken phoneme.

A component of system 10 may include an interface, logic, memory, and/or other suitable element. An interface receives input, sends output, processes the input and/or output, and/or performs other suitable operations. An interface may comprise hardware and/or software.

Logic performs the operations of the component, for example, executes instructions to generate output from input. Logic may include hardware, software, and/or other logic. Logic may be encoded in one or more tangible media and may perform operations when executed by a computer. Certain logic, such as a processor, may manage the operation of a component. Examples of a processor include one or more computers, one or more microprocessors, one or more applications, and/or other logic.

A memory stores information. A memory may comprise one or more tangible, computer-readable, and/or computer-executable storage media. Examples of memory include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or other computer-readable medium.

Modifications, additions, or omissions may be made to system 10 without departing from the scope of the invention. The components of system 10 may be integrated or separated. Moreover, the operations of system 10 may be performed by more, fewer, or other components. For example, the operations of conceptual graph generator 40 and conceptual graph expander 44 may be performed by one component, or the operations of onomasticon manager 39 may be performed by more than one component. Additionally, operations of system 10 may be performed using any suitable logic comprising software, hardware, and/or other logic. As used in this document, “each” refers to each member of a set or each member of a subset of a set.

FIG. 3C illustrates examples of onomasticons 54a and 54b. In particular embodiments, a conceptual graph, such as query conceptual graph 70b or spoken media file conceptual graph 70e, may be expanded to yield expanded conceptual graphs. In the illustrated example, onomasticon 54a is an onomasticon for person, and onomasticon 59b is an onomasticon for bomb.

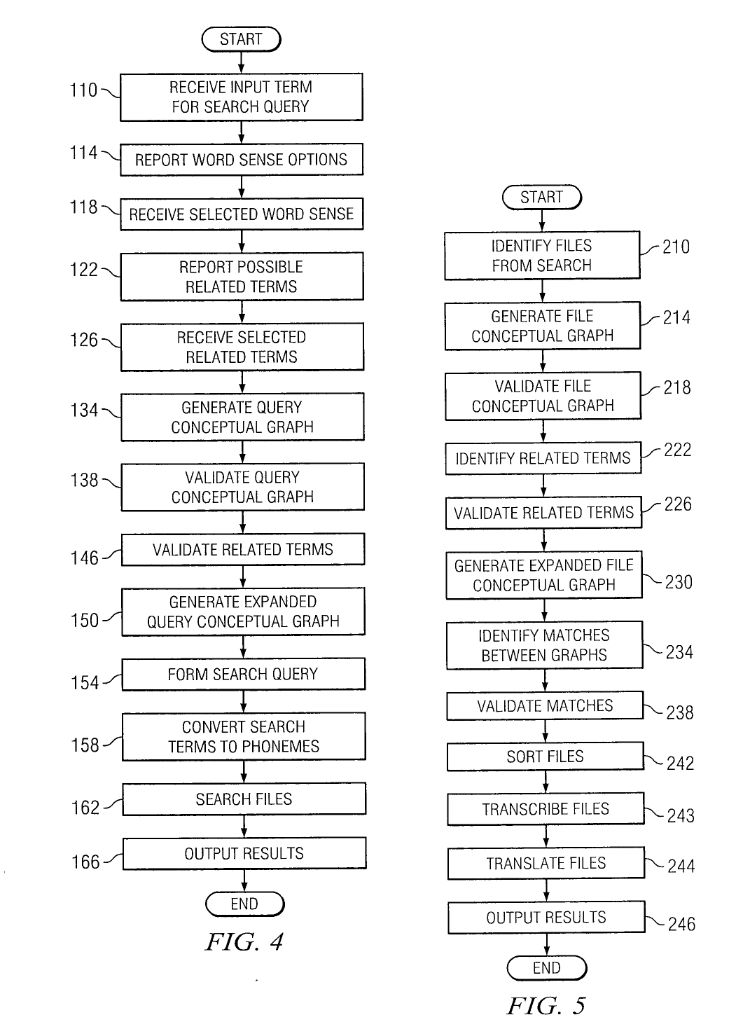

FIG. 4 illustrates an example of a method for generating and expanding terms representing concept types of a query conceptual graph 70b to generate phonemes to search spoken media files. System 10 receives an input search query at step 110. The input search query may include one or more terms, for example, one or more search terms for a query. In one example, the input search query includes “bomb.” Onomasticon manager 39 may store input search query in onomasticon 54.

In the example, steps 110 through 126 describe determining a semantic context of the search query. The semantic context of a term of a query is the context of the term based on the meaning of the term. Term expander 29 reports word sense options for the input search terms at step 114. A word sense may indicate the use of a term in a particular semantic context. In the example, the word sense options for “bomb” may include “to bomb a test” and “explosive device fused to detonate under certain conditions.” Term expander 29 may determine the word sense options for one or more terms of the input search query, and may retrieve the word sense options from onomasticon 54 and/or word ontology 50.

A word sense may be selected from the word sense options automatically or by a user. A selected word sense is received by term expander 29 at step 118. Onomasticon manager 39 may map the selected word sense to the input search and store the mapping in onomasticon 54. Word ontology 50 may determine terms semantically related to the selected word sense.

Term expander 29 reports related term options associated with the selected word sense at step 122. Related terms may be terms that are similar to a seed concept term (such as a term from the query). Term expander 29 may identify related term options from the word sense. The options may be retrieved from onomasticon 54 and/or ontology 50. For example, the related terms for the seed concept “bomb” may include “explosive device”, “pipe bomb,” “shoe bomb,” and “car bomb.”

One or more related terms may be selected (by a user or automatically) to indicate the semantic concept of the seed term of the search query. Selected related terms are received at step 126 from onomasticon 54 and/or ontology 50. Onomasticon manager 39 may map the selected related terms to the input search and/or to the seed concept term and store the mappings in onomasticon 54. To obtain related foreign terms, certain native terms may be translated into foreign terms by translator 36. The foreign terms may then be used to select related foreign terms.

Query conceptual graph 70b is generated at step 134. For example, conceptual graph generator 40 may generate query conceptual graph 70b from the semantic context of the input search query. Conceptual graph generator 40 may use context generator 46 to determine the parts of speech of seed concept term and generated terms to determine if the terms represent concept objects or context linking concepts.

Query conceptual graph 70b is validated at step 138. Logic engine 34 may validate query conceptual graph 70b as described herein. The related terms representing seed concepts are validated at step 146. Concept analyzer 38 may validate a related term by checking whether attributes mapped to the seed concept term are also mapped to the related terms that may represent the seed concept term. Onomasticon manager 39 may update onomasticon 54 to include only mappings for validated related terms that represent seed concept terms.

An expanded query conceptual graph 70b is generated at step 150. Conceptual graph expander 44 may generate expanded query conceptual graph 70b with the validated related terms. For example, conceptual graph generator 40 may use validated expanded terms produced by steps 110 through 146 to expand the concept types used in a conceptual graph to yield an expanded conceptual graph.

A search query is formed in accordance with the expanded query concept graph 70b at step 154. Query may be formed from the semantic context (for example, the selected related terms) or from the expanded query concept graph 70b.

The search terms of the search query are converted to phonemes at step 158. For example, spoken media module 37 may convert the search terms to phonemes that can be used search spoken media files 59 that may include recorded speech. Spoken media files 59 are searched at step 162. Spoken media module 37 may have previously indexed audio speech of spoken media files 59 based on phonemes included in spoken media files 59. A spoken media file 59 may be retrieved if it has phonemes that match the phonemes of the search query.

Results are output at step 166. The output may be provided to client 20, conceptual generator 40, and/or spoken media module 37. In particular embodiments, transcriber 57 may transcribe spoken audio to text that may be provided as output. In certain embodiments, translator 36 may translate transcribed spoken media files 59 from one language to another, such as from a foreign language to a native language, to yield output at step 166. In particular embodiments, spoken media module 37 may translate the phonemes of files 59 to graphemes that may be provided as output. Spoken media module 37 may play the phonemes of spoken media files 59.

Modifications, additions, or omissions may be made to the method without departing from the scope of the invention. The method may include more, fewer, or other steps. Additionally, steps may be performed in any suitable order.

FIG. 5 illustrates an example of a method for generating and expanding terms representing concept types of conceptual graph 70e generated for a spoken media file 59. Spoken media files 59 resulting from a search are identified at step 210. Spoken media file conceptual graphs 70e are generated for spoken media files 59 at step 214. For example, conceptual graph generator 40 may generate conceptual graph 70e as described herein.

The spoken media file conceptual graphs 70e are validated at step 218. Logic engine 34 may validate spoken media file conceptual graphs 70e as described herein. Onomasticon manager 39 may map spoken media file conceptual graph 70e to the spoken media file identifier of the spoken media file 59 that graph 70e represents and store the mapping in onomasticon 54.

Related terms representing seed concepts of conceptual graph 70e are identified at step 222. In the example, term expander 29 determines a semantic context of a seed concept term of conceptual graph 70e. The semantic context may be the context of the term based on the meaning of the term. Term expander 29 reports word sense options for the seed concept term in a particular semantic context. A word sense may be selected from the word sense options automatically or by a user. Term expander 29 reports related term options associated with the selected word sense. One or more related terms to represent seed concept terms may be selected to designate the semantic concept of the seed term of conceptual graph 70e. Selected related terms are received from onomasticon 54 and/or ontology 50. These procedures may be substantially similar to those of steps 114, 118, 122 and 126 of FIG. 4.

Onomasticon manager 39 may retrieve the related terms from onomasticon 54. The related terms are validated at step 226. This procedure may be substantially similar to that of step 146 of FIG. 4. Expanded spoken media file conceptual graphs 70e are generated at step 230. This procedure may be substantially similar to that of step 150 of FIG. 4.

Matches between query conceptual graph 70b and spoken media file conceptual graphs 70e are identified at step 234. Conceptual graph matcher 48 may identify the matches. The matches between the expanded spoken media file conceptual graphs and the query conceptual graph are validated at step 238. Conceptual graph matcher 48 may use logic engine 34 and/or concept analyzer 38 to validate the matches.

Spoken media files 59 may be sorted at step 242. Conceptual graph matcher 48 may sort spoken media files 59 according to semantic proximity. In particular embodiments, certain spoken media files 59 may be transcribed at step 243. In particular embodiments, spoken media files 59 may be translated at step 244. Results are output to client 20 at step 246. This procedure may be substantially similar to that of step 166 of FIG. 4.

Modifications, additions, or omissions may be made to the method without departing from the scope of the invention. The method may include more, fewer, or other steps. Additionally, steps may be performed in any suitable order.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the following claims.

What is claimed is:

1. A method comprising:
receiving a search query comprising one or more search terms;
expanding at least one search term to yield a set of conceptually equivalent terms;
converting the set of conceptually equivalent terms to a set of search phonemes;
searching a plurality of files according to the set of search phonemes, the plurality of files stored in one or more tangible storage media, a file recording one or more phonemes;
selecting a file that includes a phoneme that matches the at least one search phoneme; and
outputting the file to a client.

2. The method of claim 1, further comprising:
translating the selected file from a foreign language to a native language.

3. The method of claim 1, the file comprising a spoken media file.

4. The method of claim 1, further comprising:
translating at least one phoneme of the selected file to one or more graphemes.

5. The method of claim 1, the outputting the file to the client further comprising:
playing at least one phoneme of the selected file.

6. The method of claim 1, the outputting the file to the client further comprising:
displaying one or more graphemes corresponding to at least one phoneme of the selected file.

7. The method of claim 1:
further comprising:
generating a query conceptual graph for the one or more search terms, the query conceptual graph comprising a plurality of graph terms;
the expanding the at least one search term further comprising:
generating an expanded query conceptual graph from the query conceptual graph and the set of conceptually equivalent terms; and
the converting the set of conceptually equivalent terms further comprising:
converting at least one graph term of the graph terms of the expanded query conceptual graph to the at least one search phoneme.

8. The method of claim 1:
further comprising:
generating a query conceptual graph for the one or more search terms, the query conceptual graph comprising a plurality of graph terms; and
identifying a set of conceptually equivalent terms for each graph term of one or more graph terms of the plurality of graph terms;
the expanding the at least one search term further comprising:
generating an expanded query conceptual graph from the query conceptual graph and the set of related terms by expanding the each graph term with the set of conceptually equivalent terms; and
the converting the set of conceptually equivalent terms further comprising:
converting at least one graph term of the graph terms of the expanded query conceptual graph to the at least one search phoneme.

9. The method of claim 1, the searching the plurality of files according to the at least one search phoneme further comprising:
generating a corresponding file conceptual graph for each file of a subset of the files; and
selecting a file if the corresponding file conceptual graph matches a query conceptual graph generated for the search query.

10. The method of claim 1, the searching the plurality of files according to the at least one search phoneme further comprising:
generating a corresponding expanded file conceptual graph for each file of a subset of the files; and
selecting a file if the corresponding expanded file conceptual graph matches an expanded query conceptual graph generated for the search query.

11. An apparatus comprising:
one or more tangible storage media configured to store:
a plurality of files, a file recording one or more phonemes; and
computer executable instructions when executed operable to:
receive a search query comprising one or more search terms;
expand at least one search term to yield a set of conceptually equivalent terms;
convert the set of conceptually equivalent terms to a set of search phonemes;
search the plurality of files according to the set of search phonemes;
select a file that includes a phoneme that matches the at least one search phoneme; and
output the file to a client.

12. The apparatus of claim 11, the instructions further operable to:
translate the selected file from a foreign language to a native language.

13. The apparatus of claim 11, the file comprising a spoken media file.

14. The apparatus of claim 11, the instructions further operable to:
translate at least one phoneme of the selected file to one or more graphemes.

15. The apparatus of claim 11, the instructions further operable to output the file to the client further by:
playing at least one phoneme of the selected file.

16. The apparatus of claim 11, the instructions further operable to output the file to the client further by:
displaying one or more graphemes corresponding to at least one phoneme of the selected file.

17. The apparatus of claim 11, the instructions further operable to:
generate a query conceptual graph for the one or more search terms, the query conceptual graph comprising a plurality of graph terms;
expand the at least one search term by:
generating an expanded query conceptual graph from the query conceptual graph and the set of conceptually equivalent terms; and
convert the set of conceptually equivalent terms by:
converting at least one graph term of the graph terms of the expanded query conceptual graph to the at least one search phoneme.

18. The apparatus of claim 11, the instructions further operable to:
generate a query conceptual graph for the one or more search terms, the query conceptual graph comprising a plurality of graph terms; and
identify a set of conceptually equivalent terms for each graph term of one or more graph terms of the plurality of graph terms;
expand the at least one search term by:
generating an expanded query conceptual graph from the query conceptual graph and the set of related terms by expanding the each graph term with the set of conceptually equivalent terms; and
convert the set of conceptually equivalent terms by:
converting at least one graph term of the graph terms of the expanded query conceptual graph to the at least one search phoneme.

19. The apparatus of claim 11, the instructions further operable to search the plurality of files according to the at least one search phoneme by:
generating a corresponding file conceptual graph for each file of a subset of the files; and
selecting a file if the corresponding file conceptual graph matches a query conceptual graph generated for the search query.

20. The apparatus of claim 11, the instructions further operable to search the plurality of files according to the at least one search phoneme by:
generating a corresponding expanded file conceptual graph for each file of a subset of the files; and
selecting a file if the corresponding expanded file conceptual graph matches an expanded query conceptual graph generated for the search query.

21. An apparatus comprising:
one or more tangible storage media configured to store:
a plurality of files, a file recording one or more phonemes and comprising a spoken media file; and
computer executable instructions when executed operable to:
receive a search query comprising one or more search terms;
generate a query conceptual graph for the one or more search terms, the query conceptual graph comprising a plurality of graph terms;
expand at least one search term to yield a set of conceptually equivalent terms, the at least one search term expanded by:
generating an expanded query conceptual graph from the query conceptual graph and the set of conceptually equivalent terms; and
convert the set of conceptually equivalent terms to a set of search phonemes, the set of conceptually equivalent terms converted by:
converting at least one graph term of the graph terms of the expanded query conceptual graph to the at least one search phoneme;
search the plurality of files according to the set of search phonemes;
select a file that includes a phoneme that matches the at least one search phoneme; and
output the file to a client.

22. The apparatus of claim 21, the instructions further operable to:
generate a query conceptual graph for the one or more search terms, the query conceptual graph comprising a plurality of graph terms;
expand the at least one search term by:
generating an expanded query conceptual graph from the query conceptual graph and the set of conceptually equivalent terms; and
convert the set of conceptually equivalent terms by:
converting at least one graph term of the graph terms of the expanded query conceptual graph to the at least one search phoneme.

23. The apparatus of claim 21, the instructions further operable to:
generate a query conceptual graph for the one or more search terms, the query conceptual graph comprising a plurality of graph terms; and
identify a set of conceptually equivalent terms for each graph term of one or more graph terms of the plurality of graph terms;
expand the at least one search term by:
generating an expanded query conceptual graph from the query conceptual graph and the set of related terms by expanding the each graph term with the set of conceptually equivalent terms; and
convert the set of conceptually equivalent terms by:
converting at least one graph term of the graph terms of the expanded query conceptual graph to the at least one search phoneme.

24. The apparatus of claim 21, the instructions further operable to search the plurality of files according to the at least one search phoneme by:
generating a corresponding file conceptual graph for each file of a subset of the files; and
selecting a file if the corresponding file conceptual graph matches a query conceptual graph generated for the search query.

25. The apparatus of claim 21, the instructions further operable to search the plurality of files according to the at least one search phoneme by:
generating a corresponding expanded file conceptual graph for each file of a subset of the files; and
selecting a file if the corresponding expanded file conceptual graph matches an expanded query conceptual graph generated for the search query.
